(19) United States
(12) Patent Application Publication
(10) Pub. No.: US 2025/0049639 A1
(43) Pub. Date: Feb. 13, 2025

(54) DISPENSING DEVICE FOR MEDICAMENTS COMPRISING A DOSE SELECTION AND DOSE SEPARATION MECHANISM

(71) Applicant: Iconovo AB, Lund (SE)

(72) Inventor: Orest Lastow, TORNA HÄLLESTAD (SE)

(21) Appl. No.: 18/723,001

(22) PCT Filed: Nov. 25, 2022
(86) PCT No.: PCT/SE2022/051102

§ 371 Date: Jun. 21, 2024

(30) Foreign Application Priority Data
Dec. 21, 2021 (SE) 2151570-5

(51) Int. Cl. A61J 7/00; A61J 1/03

(52) U.S. Cl. CPC A61J 7/0076; A61J 1/03

(57) ABSTRACT

A dispensing device for dispensing a dose of a medicament is provided. The device includes a feed channel configured to receive a plurality of dosage units of a medicament, a dose selector configured to receive an input specifying a number of dosage units of the medicament to be dispensed from the feed channel, a dose separator configured to separate a subset of the dosage units from the plurality of dosage units in the feed channel, and a dose dispenser configured to dispense the separated subset of the dosage units from the feed channel. The dose selector is mechanically coupled to the dose separator to enable the dose separator to separate the specified number of dosage units from the plurality of dosage units in the feed channel.

### CROSS-REFERENCE TO RELATED APPLICATIONS

This application claims priority to International Patent Application No. PCT/SE2022/051102, filed on Nov. 25, 2022, and to Swedish Application No. SE 2151570-5 filed on Dec. 21, 2021, the contents of both are hereby incorporated by reference in their entirety.

### TECHNICAL FIELD

The present application relates to a dispensing device for delivering dosage units of a medicament to a user.

### BACKGROUND

Many conditions or diseases require regular consumption of medication by a person suffering from the condition. Such conditions may include Parkinson's disease, attention deficit-hyperactivity disorder (ADHD), depression, anxiety, type-2 diabetes, oncology (e.g., chemotherapy), break-through pain (e.g., palliative care in cancer), thrombosis, thyroid disease, incontinence, and other known conditions and diseases.

Sufferers of such conditions may need to take medication at periodic intervals (for example, daily, a number of times per day, etc.). Each time a person takes medication, a specific dose is often required. This dose can be measured, for example, in a number of milligrams of a particular medicament, and may be from a few milligrams to several hundred-milligrams. The medicament may be delivered in one or more discrete dosage units, for example a tablet or capsule. For example, a person may need to take four tablets, three times a day.

In some cases, the medicament is delivered in one or more microtablets. Microtablets are considered as those smaller than regular tablets, although no standard size has been specified. For example, a microtablet may have a diameter of a few millimetres up to tens of millimetres, and may contain a dose of a few milligrams of a medicament up to tens of milligrams. In such instances, a person may be required to take a larger number of tablets, for example 15, 20 or more, in each dose. Given the size and number of microtablets that must be delivered in each dose, it can become problematic to count the correct number and ensure the correct dose is delivered. This may particularly be the case for people with motor disorders, cognitive disorders, vision problems, and for elderly people or children.

Dispensing devices are known that use sensors to detect how many dosage units are released from the device in each dose. Dispensing devices are also known that use a motor and electronic controller to drive a dosing mechanism to dispense a determined number of dosage units from a separate and disposable magazine. However, such devices are complicated and expensive to produce, and require batteries that must be regularly recharged or replaced. These devices involve many interoperable components, the failure of any of which may result in an incorrect number of dosage units being dispensed and therefore an incorrect dose of the medicament being consumed.

It is therefore desired to provide a dispensing device that is capable of accurately dispensing a specified number of dosage units, has a simple construction, and is capable of operation without electrical power.

### SUMMARY

The present disclosure attempts to solve at least some of the aforementioned issues by providing a device for dispensing a dose of a medicament wherein a dose selection mechanism is mechanically coupled to a dose selection mechanism and a dose dispensing mechanism such that a specified number of dosage units can be dispensed from the device without the use of complex additional components such as counters, sensors, controllers and the like.

According to an aspect, there is provided a dispensing device for dispensing a dose of a medicament, the device comprising; a feed channel configured to receive a plurality of dosage units of a medicament; a dose selection mechanism configured to receive an input specifying a number of dosage units of the medicament to be dispensed from the feed channel; a dose separation mechanism configured to separate a subset of the dosage units from the plurality of dosage units in the feed channel; and a dose dispensing mechanism configured to dispense the separated subset of the dosage units from the feed channel; wherein the dose selection mechanism is mechanically coupled to the dose separation mechanism to enable the dose separation mechanism to separate the specified number of dosage units from the plurality of dosage units in the feed channel.

### BRIEF DESCRIPTION OF THE DRAWINGS

Exemplary embodiments of the disclosure shall now be described with reference to the drawings in which:

FIG. 1 shows a dispensing device according to an embodiment;

FIGS. 2A to 2E schematically show the internal components of a dispensing device according to an embodiment; and

FIGS. 3A and 3B schematically show the internal components of a dispensing device according to an embodiment in cross-section.

Throughout the description and the drawings, like reference numerals refer to like parts.

### DETAILED DESCRIPTION

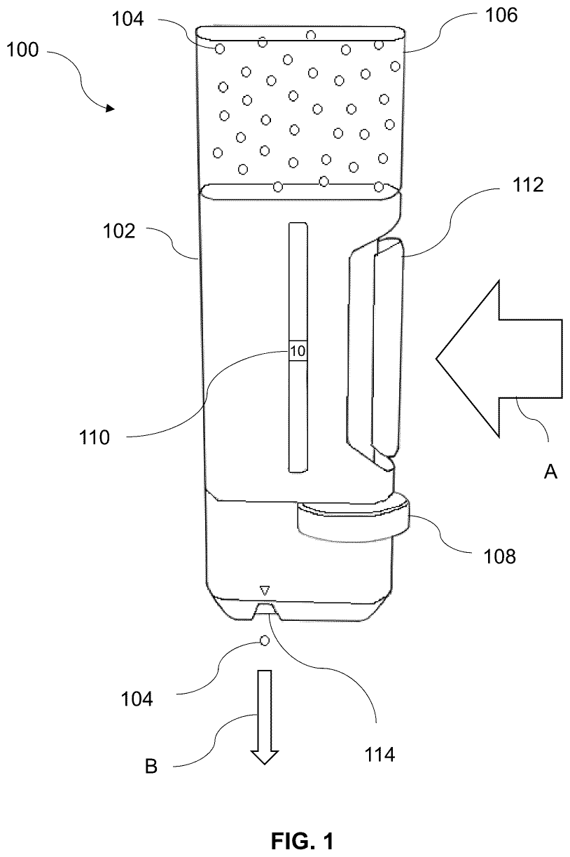

FIG. 1 shows a dispensing device 100 for dispensing a dose of a medicament. A medicament is provided in a number of dosage units, such as tablets, capsules, pellets or microtablets. The medicament may be for one of a number of diseases or conditions, such as Parkinson's disease, attention deficit-hyperactivity disorder (ADHD), depression, anxiety, type-2 diabetes, oncology, break-through pain, thrombosis, thyroid disease, incontinence, etc. Example medicaments include levodopa, methylphenidate, warfarin, levothyroxine, etc. The dispensing device 100 allows a user to release a number of dosage units of the medicament for consumption as and when necessary.

The device 100 comprises a housing 102 configured to house the internal components of the device. The housing 102 may be formed of plastic, such as polyethylene, polypropylene, polystyrene, polycarbonate, etc., or any other suitable material. The device 100 may be handheld and/or portable, to enable the user to carry it with them and use it on-demand. The device 100 is configured to store a number of dosage units 104 for dispensing to a user. The dosage units 104 may be solid medicament units such as tablets, pellets or microtablets, or liquid or powder medicament stored in a hard shell such as a capsule. The dosage units 104 may be substantially spherical, near-spherical, or disc-shaped. In particular, the dosage units should have a measurable dimension that can be used to determine how many dosage units 104 are dispensed, as will be explained below. It is advantageous that all dosage units 104 stored in the device 100 are of the same shape and size, or have the same measurable dimension (for example the same diameter). In one example, the dosage units 104 may be spherical microtablets with a diameter of 5 mm.

The dosage units 104 may be stored in a medicament storage chamber 106. The medicament storage chamber 106 may be formed integrally with the housing 102, or may be a separate component that can be attached to the housing 102. The medicament storage chamber 106 may be formed of a transparent material, such that the user may easily see how many dosage units 104 are left in the device 100. A transparent medicament storage chamber 106, or any medicament storage chamber 106 that looks different from the rest of the housing 102, also allows the user to easily orient the device 100 during use. In some examples, the medicament storage chamber 106 may contain around 1000 microtablets and have a volume of around 100 ml, or contain around 5000 microtablets and have a volume of around 500 ml. However, it will be appreciated that the medicament storage chamber 106 may have any suitable capacity or volume.

In embodiments where the medicament storage chamber 106 is formed integrally with the housing 102, the device 100 may be a disposable device that is replaced when all the dosage units 104 have been consumed. In embodiments where the medicament storage chamber 106 is a separate component that can be attached to the housing 102, the medicament storage chamber 106 may take the form of a cassette or magazine containing a number of dosage units 104. In these embodiments, the cassette or magazine can be replaced when all the dosage units 104 have been consumed and the device 100 can be reused.

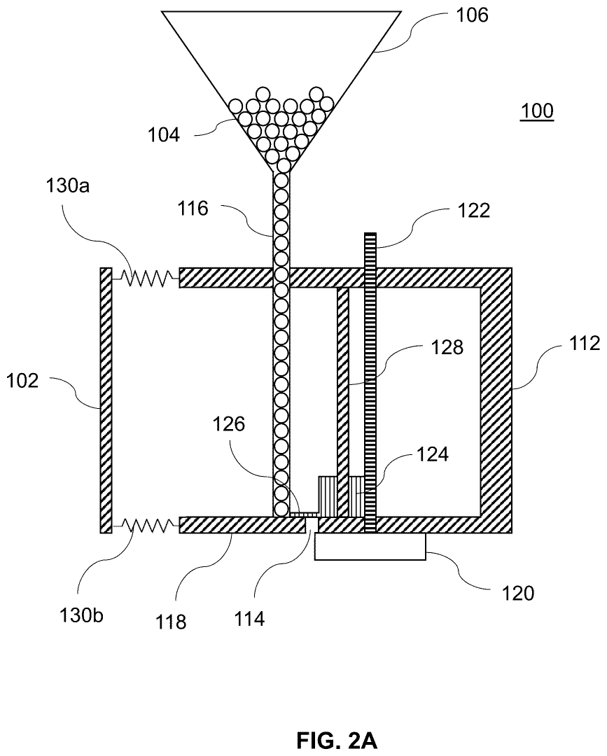

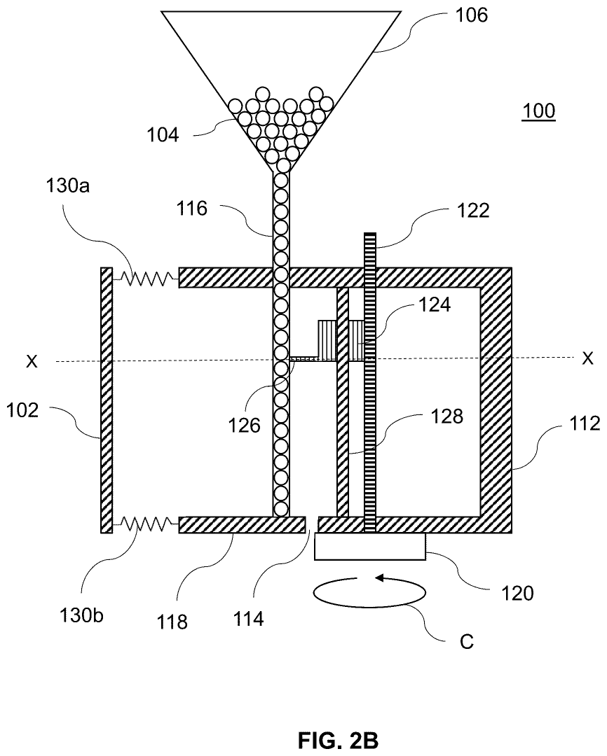

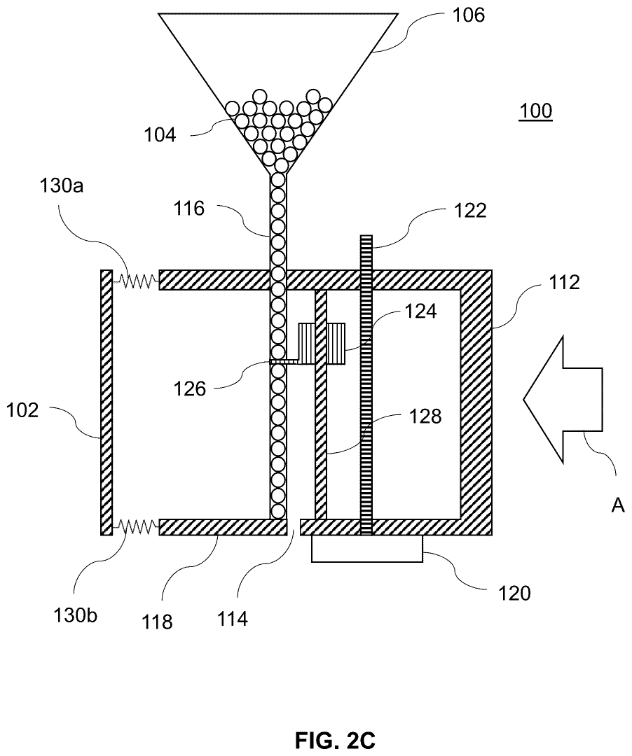

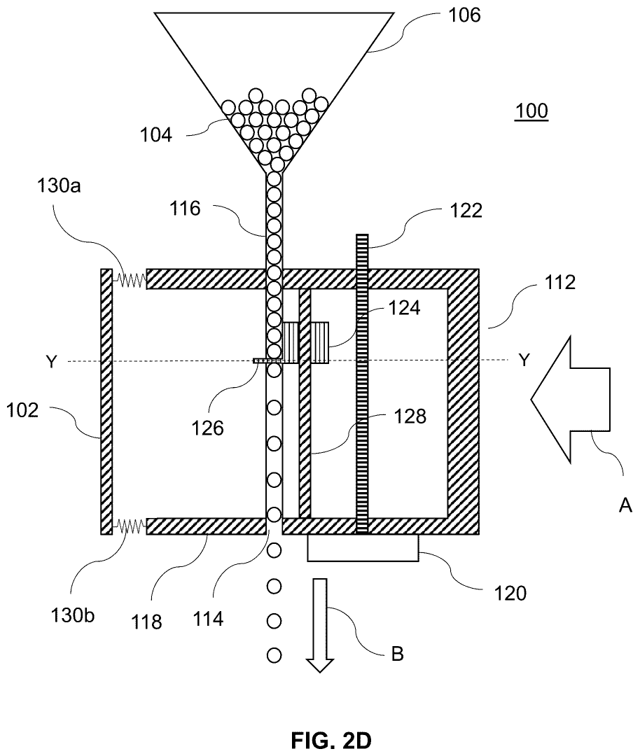

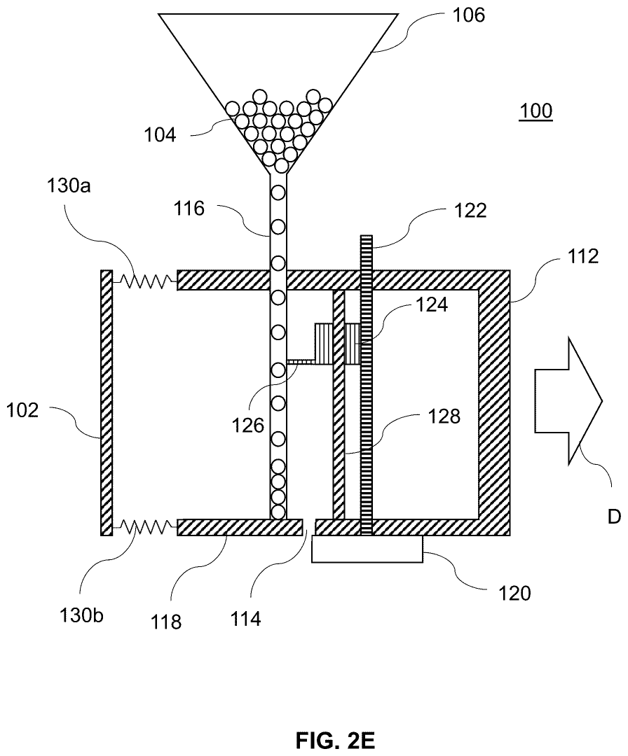

The device 100 also comprises a dose selection mechanism 108. The dose selection mechanism allows a user to provide an input specifying a number of dosage units 104 of the medicament to be dispensed from the device 100. In some examples, the specified number of dosing units 104 to be dispensed in a single dose is between 1 and 30. In FIG. 1, the dose selection mechanism 108 comprises a dose input element in the form of a wheel, which can be rotated by the user to select an intended number of dosage units to be dispensed. The dose selection mechanism 108 is explained in more detail in relation to FIGS. 2A-E.

A dose indicator 110 may also be provided on the device 100 to indicate the specified number of dosage units 104 to the user. This provides a simple interface for the user to select a number of dosage units 104 to be dispensed. The dose indicator 110 may be a visual dose indicator, which displays the number such that it can be read by the user. For example, the dose indicator 110 can include a component coupled to gear and to the dose selection mechanism 108, such that the specified number is displayed in a window. The dose indictor 110 may also comprise a rod with pre-printed numbers that move, or a strip/tape that is pulled up and down. The dose indicator 110 may be coupled to the dose selection mechanism 108 such that, when the dose selection mechanism 108 is actuated, the dose indicator is updated to reflect the specified number of dosage units 104. As discussed above, the specified number of dosing units 104 to be dispensed in a single dose may be between 1 and 30. In the example of FIG. 1, the specified number of dosing units 104 is shown as being 10.

The device 100 also comprises a dose dispensing mechanism 112. The dose dispensing mechanism 112 is configured to dispense the specified number of dosage units 104 from device 100. The dose dispensing mechanism 112 may be a button, lever or the like that can be actuated in a direction indicated by the arrow A, i.e. transversally to the device 100. When the dose dispensing mechanism 112 is actuated, the device 100 dispenses the specified number of dosage units 104 from an aperture 114. The aperture 114 may be marked or indicated in some way to show the user where the dosage units 104 will be dispensed from the device 100. The dosage units 104 may be dispensed generally in a direction indicated by the arrow B, i.e. axially to the device 100.

The dispensed dosage units 104 can then be collected by the user, for example in their hand or in a glass, for consumption. As will be explained in relation to FIGS. 2A-E, the device 100 is configured such that the specified number of dosage units 104 is maintained until the dose selection mechanism 108 is further actuated. That means that each time the dose dispensing mechanism 112 is actuated, the same number of dosage units 104 is dispensed from the device 100. This can be helpful in cases where the user is required to take the same dose of the medicament at repeated intervals or if the user has a default dose value from which minor departures can be expected. In the latter case, only minor adjustments are needed to go back to the default dose value or to obtain the somewhat adapted dose value. In some embodiments, the dose selection mechanism 108 may be locked, such that the user cannot change the number of dosage units 104 dispensed from the device 100.

FIGS. 2A-E schematically show the internal components of a dispensing device 100 according to an example. FIGS. 2A-E illustrate how the device 100 is used to dispense a specified number of dosage units 104 to a user. The dose dispensing mechanism 112 is actuatable between a first position, shown in FIG. 2A, and a second position, shown in FIG. 2D.

FIG. 2A shows the device 100 in a neutral or resting position, where the dose dispensing mechanism 112 is in the first position in which it is not actuated. The device 100 comprises a feed channel 116 disposed in the housing 102, and extending axially of the device 100. The feed channel 116 is configured to receive a plurality of dosage units 104. As shown in FIG. 2A, the dosage units 104 may be stored in a medicament storage chamber 106 and be provided therefrom into the feed channel 116. In some embodiments, the dosage units pass into the feed channel under the action of gravity. It will be envisaged that other mechanisms could be implemented to provide dosage units 104 from the medicament storage chamber 106 to the feed channel 116, for example some sort of pressure-applying component to push dosage units 104 into the feed channel 116. However, when the storage chamber 106 provides dosage units 104 to the feed channel 116 by the aid of gravity, the device 100 would be simplified in its construction with no need of additional pressure generating means. In the embodiment wherein the dosage units 104 are fed into the feed channel via gravity, it is preferred if the medicament storage chamber has walls slanting towards the feed channel 116, to facilitate gravity feed. In some embodiments, the medicament storage chamber 106 may be absent and all dosage units 104 in the device 100 may be provided in the feed channel 116.

The feed channel 116 may be closed at a dispensing end to prevent dosage units 104 from falling out of the feed channel 116 before the dose dispensing mechanism 112 is actuated. This closure may be provided by a leg 118 of the dose dispensing mechanism 112. The leg 118 of the dose dispensing mechanism 112 may also comprise the aperture 114, which enables the dosage units 104 to be dispensed, as will be explained in relation to FIG. 2D, as the leg 118 is displaced transversally of the feed channel 116 and device 100 upon actuation of the dose dispensing mechanism 112 in the transversal direction.

In some embodiments, the feed channel 116 is implemented as a linear tube or cylinder. The cylinder may have a substantially circular cross-section in the transversal direction. The feed channel 116 may have a diameter corresponding to a diameter of a single dosage unit 104 of the medicament. In this way, the dosage units 104 present in the feed channel 116 can be arranged one-by-one, substantially in a column. For example, if the diameter of a spherical microtablet is 5 mm, the feed channel 116 may have a diameter slightly larger than 5 mm to allow only a single microtablet to pass through the feed channel 116 at a time. A first microtablet may rest on the leg 118 at the end of the feed channel 116, and subsequent microtablets are then stacked on top of the first microtablet, forming a column of microtablets in the feed channel 116. As will be appreciated from the following description of the function of the device 100, the feed channel 116 may be implemented in any suitable form that allows dosage units 104 to be arranged in one or more aligned columns. For example, for microtablets with a diameter of 5 mm, the feed channel 116 may be implemented with a rectangular cross section having a length slightly above 15 mm and a width slightly above 5 mm. This would allow three microtablets having diameters of 5 mm to form a row at the bottom of the channel, and further rows of three microtablets to be stacked on top, forming three columns in the feed channel. In this way the device 100 may be more compact, with a decreased axial extension in comparison with embodiments with one column of dosage units 104. In the case of a disc-shaped dosage unit 104, for example, having a diameter of 5 mm and a thickness of 2 mm, the feed channel 116 may be implemented with a rectangular cross section having a length slightly above 5 mm and a width slightly above 2 mm, such that the disc-shaped dosage units 104 form a column.

Also shown in FIG. 2A is the dose selection mechanism 108. In the embodiment shown in FIG. 2A, the dose selection mechanism comprises a dose input element 120 in the form of a wheel coupled to a threaded axle 122. When the wheel 120 is rotated, the threaded axle 122 is also rotated, in turn positioning a dose separation mechanism 124. As will be explained in relation to FIGS. 2B-E, the dose selection mechanism 108 positions the dose separation mechanism 124 at an axial position relative to the feed channel 116 corresponding to a specified number of dosage units 104. The dose selection mechanism 108 may also comprise a gear mechanism to improve precision. In some embodiments, the dose selection mechanism 108 has a tactile feedback mechanism, for example a click mechanism, to indicate to the user that a particular rotation of the wheel 120 has been made. For example, the dose selection mechanism may click each time the wheel 120 has been sufficiently rotated to increase the dose by one dosage unit.

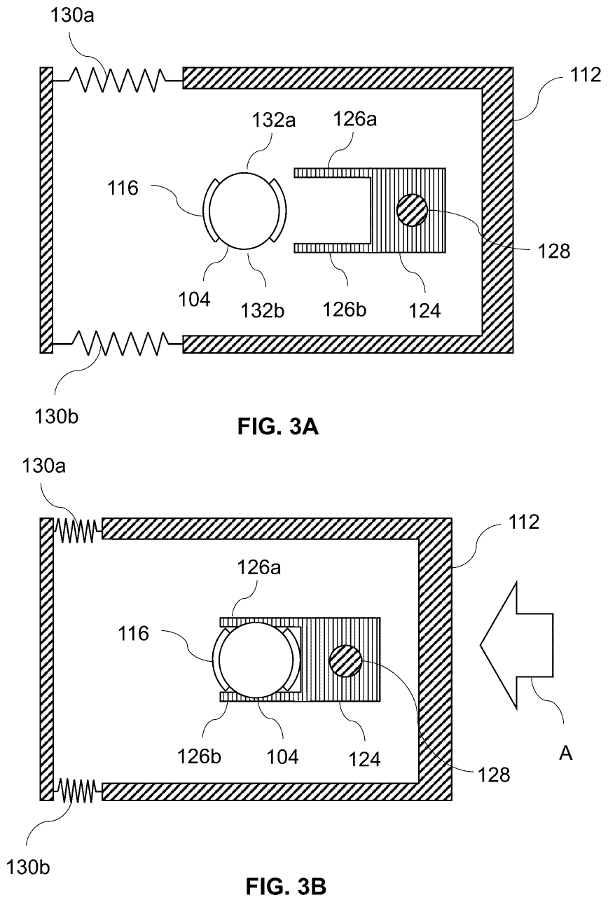

The dose separation mechanism 124 is configured to separate a subset of the dosage units 104 from the plurality of dosage units 104 in the feed channel 116. To achieve this, the dose separation mechanism 124 comprises at least one protrusion 126 configured to be inserted into the feed channel 116. As will be explained in relation to FIGS. 2C and 2D, the at least one protrusion 126 is configured to be inserted between adjacent dosage units 104 in the feed channel 116, and obstruct movement of the dosage units 104 that are not to be dispensed, i.e. dosage units that are positioned axially towards the medicament storage chamber 106. When the dose dispensing mechanism 112 is in the first position, as shown in FIG. 2A, the dose separation mechanism 124 is not inserted into the feed channel 116. In some embodiments, the dose separation mechanism 124 comprises two protrusions and has a fork-like construction, as will be explained in relation to FIGS. 3A and 3B. The dose separation mechanism 124 is coupled to the dose dispensing mechanism 112 by an arm 128. The arm 128 maintains the dose separation mechanism 124 in a position along a fixed axis relative to the dose dispensing mechanism 112.

The dose dispensing mechanism 112 is coupled to the housing 102 such that the dose dispensing mechanism 112 can be reversibly actuated between the first and second positions. As shown in FIG. 2A, the dose dispensing mechanism 112 is coupled to the housing 102 via one or more springs 130a-b that act transversally to the device 100 and the feed channel 116. As will be explained in relation to FIG. 2E, when the dose dispensing mechanism 112 is in the second position, the springs 130a-b cause the dose dispensing mechanism 112 to be returned to the first position. When the dose dispensing mechanism 112 is in the first position, the leg 118 of the dose dispensing mechanism 112 closes a dispensing end of the feed channel 116. This prevents dosage units being dispensed from the feed channel 116.

FIG. 2B shows the device 100 once the dose selection mechanism 108 has received an input of a number of dosage units 104 to be dispensed. In order to enable the dispensing device 100 to dispense the specified number of dosage units 104, the dose separation mechanism 124 is coupled to the dose selection mechanism 108 and the dose dispensing mechanism 112. For example, the dose separation mechanism 124 may be coupled to the threaded axle 122 of the dose selection mechanism 108. As discussed above, the dose separation mechanism 124 is coupled to the dose dispensing mechanism 112 by the arm 128. To input the desired number of dosage units 104, the user rotates the wheel 120, as indicated by arrow C. Rotation of the wheel 120 causes rotation of the threaded axle 122, which in turn causes translation and displacement of the dose separation mechanism 124 along the arm 128. As such, when the dose selection mechanism 108 is actuated, the dose separation mechanism 124 is moved axially, i.e. along an axis parallel to the feed channel 116.

The dose selection mechanism 108 is configured such that the distance of translation of the dose separation mechanism 124 corresponds to the number of dosage units 104 specified by the user. That is to say, the dose selection mechanism 108 is configured to position the dose separation mechanism 124 at a position relative to the feed channel 116 corresponding to the specified number of dosage units 104. In this case, the user has input that ten dosage units 104 should be dispensed from the device 100, and the dose separation mechanism 124 has been positioned relative to the feed channel 116 to be inserted between the tenth and eleventh dosage units 104.

As the dosage units are all of the same diameter, and are arranged in one or more columns, the dose selection mechanism 108 can be configured such that the degree of rotation of the wheel 120 between consecutive numbers corresponds to a translation of the dose separation mechanism 124 by a distance corresponding to the diameter of one dosage unit 104. For example, if the dosage units have a diameter of 5 mm, and the user rotates the wheel 120 to a position corresponding to 10 dosage units, the dose separation mechanism is translated 50 mm from the bottom of the feed channel 116. Once the dose separation mechanism 124 has been correctly positioned, the dose dispensing mechanism 112 can be actuated to dispense the specified number of dosage units 104 from the feed channel 116.

FIG. 2C shows the device 100 at a first stage of actuation of the dose dispensing mechanism 112. In FIG. 2C, the dose dispensing mechanism 112 is in a third position, between the first position shown in FIG. 2A and the second position, shown in FIG. 2D. The dose dispensing mechanism 112 is actuated in a direction indicated by the arrow A, i.e. transversally to the feed channel 116. The dose dispensing mechanism 112 may be actuated by the user by hand, by simply compressing the device 100.

As the dose dispensing mechanism 112 is actuated, it in turn actuates the dose separation mechanism 124 towards the feed channel 116. The dose separation mechanism 124 is inserted into the feed channel 116 to separate a subset of the dosage units 104 from the rest of the dose units 104 in the feed channel 116. In particular, the at least one protrusion 126 is inserted into the feed channel 116 between adjacent dosage units to separate the subset of dosage units. As the dose separation mechanism 124 has been aligned with the feed channel 116 at a position corresponding to the specified number of dosage units 104, the number of dosage units that are separated is the specified number of dosage units 104 that was input by the user to the dose selection mechanism 108.

When the dose dispensing mechanism 112 is in the third position, the dispensing end of the feed channel 116 remains closed. Specifically, the aperture 114 is not yet aligned with the dispensing end of the feed channel 116, and the leg 118 of the dose dispensing mechanism 112 closes the dispensing end of the feed channel 116. This ensures that no dosage units 104 are dispensed from the device 100 before the correct number of dosage units 104 have been properly separated. This means that the specified number of dosage units 104 is dispensed, and the user receives the correct dose.

FIG. 2D shows the device 100 when the dose dispensing mechanism 112 has been actuated to the second position. In this position, the dispensing end of the feed channel 116 is open to enable the specified number of dosage units 104 to be dispensed from the feed channel 116. Specifically, the dose separation mechanism 124 remains in the feed channel 116 to separate the specified number of dosage units 104 from the rest of the dosage units 104 in the feed channel 116, and the aperture 114 of the dose dispensing mechanism 112 is aligned with the dispensing end of the feed channel 116. In this way, the at least one protrusion 126 obstructs movement of the dosage units 104 that are not to be dispensed, allowing only the specified number of dosage units 104 to be dispensed from the open feed channel 116, for example by the action of gravity. The specified number of dosage units 104 are dispensed generally in a direction indicated by the arrow B, i.e. axially.

As the dose dispensing mechanism 112 is actuated between the first position (shown in FIGS. 2A and 2B) and the second position (shown in FIG. 2D), the springs 130a-b become compressed. Once the user releases the dose dispensing mechanism 112, the springs 130a-b act to return the dose dispensing mechanism 112 from the second position to the first position, as shown in FIG. 2E. The spring force provided by the springs 130a-b forces the dose dispensing mechanism 112 in a direction indicated by the arrow D. This moves the dose dispensing mechanism 112 back to the first position. As this occurs, the aperture 114 is moved out of alignment with the dispensing end of the feed channel 116, the leg 118 of the dose dispensing mechanism 112 again closes the dispensing end of the feed channel 116. Then, the dose separation mechanism 124 is removed from the feed channel 116 and therefore no longer obstructs movement of the dosage units 104 remaining in the device 100. This enables the feed channel 116 to be refilled with dosage units 104, for example from the medicament storage chamber 106. As the leg 118 of the dose dispensing mechanism 112 closes the dispensing end of the feed channel 116 before the dose separation mechanism 124 is removed from the feed channel 116, no dosage units 104 are inadvertently released from the feed channel. It will be appreciated that the springs 130a-b could be implemented by any suitable resilient member that can force the dose dispensing mechanism 112 back to the first position once the user releases the dose dispensing mechanism 112.

Once the dose dispensing mechanism 112 has returned to the first position, the dose separation mechanism 124 stays in the position on the arm 128 corresponding to the specified number of dosage units 104. This is due to the coupling between the dose separation mechanism 124 and the dose selection mechanism 108 discussed above. This enables the device 100 to be easily reused to deliver a consistent dose of the medicament, as the dose selection mechanism 108 does not need to be reset each time the device 100 is used. In some embodiments, the dose selection mechanism 108 may be locked in position using some sort of locking mechanism known in the art, in order that the user cannot change the dose that is dispensed. The locking mechanism locks the dose separation mechanism 124 in relation to the feed channel 116, such that axial displacement of the dose separation mechanism (124) is hindered. For example, the locking mechanism may include a pin that can be inserted into the wheel 120 or a gear mechanism of the dose selection mechanism, in order to prevent further rotation. This could be performed, for example, by a doctor or pharmacist.

FIGS. 3A and 3B schematically show the internal components of a dispensing device 100 in cross-section. Specifically, FIG. 3A illustrates a cross-section of the device 100 through the line X-X in FIG. 2B, and FIG. 3B illustrates a cross-section of the device 100 through the line Y-Y in FIG. 2D.

In FIG. 3A, the dose dispensing mechanism 112 is shown in the first position. As can be seen in FIG. 3A, the dose separation mechanism 124 comprises two protrusions 126a-b configured to be inserted into the feed channel 116, giving the dose separation mechanism 124 a “fork” configuration. To accommodate the two protrusions 126a-b, the feed channel 116 comprises corresponding slots 132a-b. The slots 132a-b are configured to receive respective protrusions 126a-b when the dose dispensing mechanism 112 is moved from the first position to the second position.

In FIG. 3B the dose dispensing mechanism 112 is shown in the second position. As can be seen in FIG. 3B, the two protrusions 126a-b have been inserted into the feed channel 116 in the corresponding slots 132a-b. The slots 132a-b are each configured to receive respective protrusions 126a-b when the dose dispensing mechanism 112 is moved from the first position to the second position. The protrusions 126a-b are inserted between adjacent dosage units 104, as shown in FIG. 2D, enabling the specified number of dosage units 104 to be separated and dispensed. This fork configuration allows the dose separation mechanism 124 to be inserted into the feed channel only at the edges of the dosage units 104, which decreases the risk that the dosage units are crushed as the dose separation mechanism 124 is inserted.

In some embodiments, the slots 132a-b may be formed longitudinally along substantially the entire length of the feed channel 116, such that the protrusions 126a-b can be inserted into the feed channel 116 at any position along its length. Forming the slots 132a-b longitudinally in this way provides a simple construction of the feed channel 116. In other embodiments, slots 132a-b may be formed at specific positions along the length of the feed channel 116 corresponding to the interfaces between adjacent dosage units 104. For example, in the case that the dosage units 104 are microtablets of 5 mm diameter, slots or holes could be provided every 5 mm along the length of the feed channel 116. In yet other embodiments, the protrusion 126 may be a plate configured to be inserted into the feed channel. In this instance, corresponding slots may be formed transversally along the length of the feed channel 116, in particular, at positions corresponding to the interfaces between adjacent dosage units 104.

In some embodiments, the dispensing device 100 may be adapted to accommodate different types of dosage unit 104, for example having different sizes or different medicaments. To achieve this, the device 100 may comprise a respective feed channel 116, dose selection mechanism 108, dose separation mechanism 124, and/or dose dispensing mechanism 112 for each different type of dosage unit 104. If the different types of dosage unit 104 are of the same size but for different medicaments, the device 100 may have a respective feed channel 116 for each type of dosage unit 104, but a single dose selection mechanism 108. If the doses are to be dispenses at the same time, the device 100 may have a single dose dispensing mechanism 112.

The dispensing device disclosed above has a simple construction that is capable of accurately dispensing a specified number of dosage units of a medicament. The device may be fully mechanical, such that complex components such as sensors, controllers and the like are not required. The device may be constructed of approximately ten parts, as further components such as counters are not necessary. The device 100 may be handheld and/or portable, which enables the user to carry it with them and use it on-demand, and may also be disposable. A medicament storage chamber formed of a transparent material enables the user to easily see how many dosage units are left in the device and to easily orient the device during use. The dose selection mechanism of the device provides a simple interface for the user to select a number of dosage units to be dispensed, and the dose dispensing mechanism may be actuated by the user by hand. This makes it easy for people with motor disorders, vision problems, cognitive disorders and elderly people or children to use the device and receive the correct amount of medication. The interaction between the dose selection mechanism, the dose separation mechanism and the dose dispensing mechanism ensures that no dosage units are dispensed from the device before the correct number of dosage units have been separated, which means an accurate does is always delivered. As the device is configured such that the specified number of dosage units is maintained unless the dose selection mechanism is further actuated, the device does not need to be reset each time the user wished to dispense the same number of dosage units. In some embodiments, the dose selection mechanism may be locked in position such that the dose cannot be changed. By implementing a feed channel that allows dosage units to be arranged in one or more aligned columns, multiples of dosage units can be simply and accurately separated and dispensed from the device. A “fork” configuration of the dose separation mechanism decreases the risk that the dosage units are crushed as the dose separation mechanism is inserted into the feed channel, and forming longitudinal slots in the feed channel to receive a forked dose separation mechanism provides a simple construction.

As used herein, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc. do not preclude a plurality. Reference signs in the claims are provided merely as a clarifying example and shall not be construed as limiting the scope of the claims in any way.

1. A dispensing device, comprising;
a feed channel configured to receive a plurality of dosage units of a medicament;
a dose selector configured to receive an input specifying a number of dosage units of the medicament to be dispensed from the feed channel;
a dose separator configured to separate a subset of the dosage units from the plurality of dosage units in the feed channel; and
a dose mechanism configured to dispense the separated subset of the dosage units from the feed channel;
wherein the dose selector is mechanically coupled to the dose separator to enable the dose separator to separate the specified number of dosage units from the plurality of dosage units in the feed channel.

2. The dispensing device of claim 1, wherein the dose selector is configured to position the dose separator at a position relative to the feed channel corresponding to the specified number of dosage units.

3. The dispensing device of claim 2, wherein the dose separator selector is configured to maintain the position of the dose separator separation mechanism after the specified number of dosage units has been dispensed from the feed channel, until the dose separator selector is further actuated.

4. The dispensing device of claim 2, wherein the dose selector and/or the dose separator is configured to be locked in a position corresponding to a specified number of dosage units.

5. The dispensing device of claim 2, wherein the dose separator selector includes a rotatable input wheel coupled to a threaded axle.

6. The dispensing device of claim 5, wherein the threaded axle is mechanically coupled to the dose separator, thereby rotation of the input wheel causes movement of the dose separator relative to the feed channel.

7. The dispensing device of claim 1, wherein the dose separator includes at least one protrusion configured to be inserted into the feed channel to separate the specified number of dosage units from the plurality of dosage units in the feed channel.

8. The dispensing device of claim 7, wherein the at least one protrusion is configured to be inserted into the feed channel between adjacent dosage units to separate the specified number of dosage units from the plurality of dosage units in the feed channel.

9. The dispensing device of claim 7, wherein the dose separator includes two protrusions configured to be inserted into corresponding slots of the feed channel.

10. The dispensing device of claim 1, wherein the dose mechanism is configured to actuate the dose separator to separate the specified number of dosage units from the plurality of dosage units in the feed channel.

11. The dispensing device of claim 1, wherein the dose mechanism is actuatable between first and second positions.

12. The dispensing device of claim 11, wherein, when the dose mechanism is in the first position:
the dose separator is not inserted into the feed channel; and
a dispensing end of the feed channel is closed.

13. The dispensing device of claim 11, wherein, when the dose mechanism is in the second position:
the dose separator is inserted into the feed channel to separate the specified number of dosage units from the plurality of dosage units in the feed channel; and
a dispensing end of the feed channel is open to enable the specified number of dosage units to be dispensed from the feed channel.

14. The dispensing device of claim 11, wherein, when the dose mechanism is in a third position between the first and second positions:
the dose is inserted into the feed channel to separate the specified number of dosage units from the plurality of dosage units in the feed channel; and
a dispensing end of the feed channel is closed.

15. The dispensing device of claim 11, wherein the dose mechanism includes at least one leg, and:
in the first position, the leg closes a dispensing end of the feed channel to prevent dosage units being dispensed from the feed channel; and
in the second position, an aperture in the leg is aligned with the dispensing end of the feed channel to enable dosage units to be dispensed from the feed channel.

16. The dispensing device of claim 11, wherein the dose mechanism is actuatable from the first position to the second position by hand.

17. The dispensing device of claim 11, wherein the dose mechanism is actuatable from the second position to the first position by a spring force.

18. The dispensing device of claim 1, wherein the feed channel has a diameter corresponding to a diameter of a single dosage unit of the medicament, thereby plurality of dosage units is received in the feed channel substantially in a column.

19. The dispensing device of claim 1, wherein the feed channel has a diameter corresponding to a diameter of more than one dosage unit of the medicament, thereby the plurality of dosage units is received in the feed channel substantially in more than one columns.

20. The dispensing device of claim 1, wherein the feed channel is connected to a medicament storage chamber at an end opposite to a dispensing end of the feed channel.

21. The dispensing device of claim 1, wherein dosage units of the medicament pass through the feed channel by the action of gravity.

22. The dispensing device of claim 1, further comprising a visual dose indicator coupled to the dose selector.

23. The dispensing device of claim 1, wherein the plurality of dosage units includes at least one of microtablets, tablets, capsules, and/or pellets.

24. The dispensing device of claim 1, wherein each of the plurality of dosage units is the same size and/or has the diameter.

25. The dispensing device of claim 1, wherein the device is a handheld device.

26. The dispensing device of claim 1, further comprising two or more separate feed channels, each configured to receive a different type of dosage unit.

27. The dispensing device of claim 26, further comprising two or more dose selectors, two or more dose separator and/or two or more dose dispensing mechanisms, each corresponding to respective ones of the two or more feed channels.

28. The dispensing device of claim 1, further comprising a locking mechanism for locking the dose separator in relation to the feed channel, thereby axial displacement of the dose separator is hindered.
